(19) United States
(12) Patent Application Publication
(10) Pub. No.: US 2015/0151998 A1
(43) Pub. Date: Jun. 4, 2015

(54) Water Reclamation Apparatus and Method of Operation

(71) Applicant: H20 Reclamation Technologies LLC, Houston, TX (US)

(72) Inventors: Gary L. Stevenson, Spanishburg, WV (US); Daniel R. Whitcher, Sugar Land, TX (US)

(21) Appl. No.: 14/402,015

(22) PCT Filed: May 17, 2013
(86) PCT No.: PCT/US2013/041618

§ 371 Date: Nov. 18, 2014

Related U.S. Application Data
(60) Provisional application No. 61/649,127, filed on May 18, 2012.

(51) Int. Cl. C02F 9/00; C02F 1/44; C02F 1/06; C02F 1/461

(52) U.S. Cl. CPC C02F 9/00; C02F 1/4618; C02F 1/441; C02F 1/06; C02F 2103/10

(57) ABSTRACT

A water reclamation system is composed of a high-capacity input pump connected to an ionizer, which dissociates solid or biological particles from the water. After leaving the ionizer, the fluid stream is run through staged filter systems progressively filtering the solids from the water, which is then fed to a reverse osmosis system for further filtration. Rejected water is diverted to a series of thermal units which cause the rejected water to flash into steam which is returned to the cleaned water stream of the reverse osmosis unit for discharge or further use; the remaining water, having the remaining solids and biological materials, is sent to a fracture unit where it is incinerated at an elevated temperature. The system is designed to provide parallel backups at each part of the process allowing cleaning to take place continuously while the other parallel system is operating.

### CLAIM OF PRIORITY

This application claims priority to a United States Provisional application, U.S. Application No. 61/649,127 filed May 18, 2012, and which was granted a Foreign Filing License on May 29, 2012, all of which is incorporated herein by reference in its entirety.

### FIELD OF INVENTION

The present invention generally relates to the removal of solid and biological particles from a wastewater stream by a series of related steps to return a large fraction of potable water for continuous use; or, alternatively, discharge into public waterways. More particularly, the present invention relates to cleaning frac, industrial or biological waste water by passage through a mechanical ionizer which creates a streaming potential within the polluted water then passing the water to a filter system having a five micron first stage and a one micron second stage, then introducing the water into a reverse osmosis unit which returns cleaned water to be used by the industrial process or for discharge into a public water way after removal of at least 99.5 percent of the dissolved solids within the water. Rejected water is sent to a thermal unit which flash vaporizes the water, further removing solids from the steam generated, and the steam is introduced back to the clean output water from the reverse osmosis unit. Remaining polluted water is introduced to a fracture unit which heats the remaining fluid; vaporizing the remainder of the waste water and breaking down all remaining dissolved solids into their elemental constituents for disposal.

While this product can be adapted for use in many waste water treatment facilities, all of the discussion is limited to the recovery of frac water or waste water from oil and gas exploration or mining operations only for the purposes of exposition and in no manner as limiting to the scope of the invention claimed herein.

### BACKGROUND OF THE INVENTION

Hydraulic Fracturing is a process of pumping pressurized fluid into a rock layer creating a fracture thus releasing natural gas and other substances. Brine and brackish water from drill sites, after this use, cannot be discarded on site. Typically water is transported to old wells where it can be disposed by re-injecting it back into the ground. Transportation of brine and brackish water from drill sites in this manner is expensive and slow. Often, the water contains hydrocarbons and metals or other solids that make disposal even more costly and difficult. Public concern over the contamination of dumped frac water in public acquifers has created even more regulatory concern and public demand for the end to fracing as a means of recovery natural gas. This invention provides a cleaner, more efficient and cost-effective method of disposing of this wastewater.

Other industrial uses can include food-processing plants, such as chicken processing plants, which use tremendous volumes of water to clean slaughtered poultry. The present invention can be used to restore rinse water obtained as effluent from such plants and permit it to be legally dumped, or if appropriately cleared, to be reused as a solution for carcass cleaning. This waste water treatment can generate excessive amounts of organic contaminants requiring additional processing not described herein or materials to avoid the corrosive effects of these contaminants.

Several methods have been used to reclaim process water. The two primary methods are reverse osmosis and thermal distillation. Reverse osmosis is not practical at drill sites and other industrial settings due to the high concentration of solids in wastewater. Membranes used in reverse osmosis systems clog rapidly and maintenance and replacement of the units are cost prohibitive in these applications. Thermal distillation uses large amounts of energy to heat the water and is also cost prohibitive.

### SUMMARY OF THE INVENTION

Applicant has developed a water reclamation unit that consists of five stages that have been combined to process “frac” or polluted water with a near zero discharge of contaminants. This invention uses an ionizer to change the agglomerative physical characteristics of the solid particulate matter within the wastewater permitting easier and more efficient filtering and osmotic cleaning. Feed or contaminated water enters one of two (2) multi-media filters (MMF). Each multi-media filter is loaded with Micro Z Zeolite and gravel material. These filters remove suspended solids larger than a nominal 5-micron size. The process water then flows to the reverse osmosis unit through the cartridge filters that remove suspended solids larger than 1-micron nominal. The process feed water next enters a high-pressure pump, and then the membrane reverse osmosis filtration unit that removes over 99 percent of the remaining dissolved solids. The product water (the permeate) then leaves the unit as potable water suitable for reuse or discharge.

A cleaning/flushing subsystem allows maintenance of the water treatment unit itself. This subsystem consists of a cleaning/flush tank, a pump, controls and the associated pipe work.

An ionizer unit is arranged on the feed inlet of a high flow filtration system that feeds into a reverse osmosis unit, then into a vacuum-flashing chamber. The vacuum-flashing chamber separates the clean water from the waste. Finally, the remaining wastewater slurry flows into a solids fracturing or incinerator unit vaporizing the remaining water and reducing the remainder to charred ash. This water reclamation apparatus provides an ionizer unit connected to a pressurized source of contaminated water, such as a high volume pump; a filter system comprised of a series of staged filters; a reverse osmosis unit connected to the output from the filter system; a thermal concentrator unit connected to the output of the reverse osmosis unit; and, a fracture unit connected to the thermal concentrator to incinerate the solids removed from the input water stream to complete water reclamation.

This water reclamation apparatus begins with the ionizer unit, which is fed by a high capacity pump from the sump or source of the contaminated water. The ionizer is made up of concentric copper tubes providing communicating slits at opposed ends of the copper tubes. The concentric tubes are retained within a sleeve by a reducing lip on an inlet to the inner copper tube and a cap sealing the two copper tubes at a bottom. The ionizer unit provided herein can further contain a centralizing support member, such as threaded bolt and nut system retaining the copper tubes within the sleeve and a turbulence-inducing attachment such as a propeller carried on the threaded bolt. The turbulence-inducing attachment could be baffles or vanes or any other device to maintain the turbulent flow from the ionizer into the filter system. The ionizer unit can further contain a helical coil of silver, a helical coil of copper, and a second helical coil of silver wrapped around the inner copper tube exposing the fluid pumped through the inner tube to contact the copper and silver coils thereby creating a streaming potential of the electrolytic fluids contacting the copper and silver elements of this ionizer unit.

This water reclamation apparatus is designed to operate continuously because the filters provide dual inline high-flow filtration units which allow one filter to be backwashed while the other continues to filter the flow of water from the inlet of the system. Accordingly, each of the water reclamation apparatus filter system consists of a 5-micron filter system having an outlet attached to high-pressure pump system moving the water into a second 1-micron filter system. Each 5-micron filter line is redundant with a second filter system of equivalent capacity allowing continuous operation of the filters.

Since the filter system comprises a parallel operating identical system permitting continuous operation of one filter stream while backwashing the second filter system stream, the water injected into the reverse osmosis unit is highly filtered of dissolved solids even before being injected into the reverse osmosis unit. At each step of the process, backup systems permit the system elements to be bypassed if a unit fails or if operating conditions don't require the continuous full operation of the system.

The reverse osmosis (RO) filter system is attached to the dual inline filter to further filter and clean the water flowing in the system. Cleaned effluent from the reverse osmosis filter is returned to use as potable water and a rejected water line is passed through a sonic reducer, maintaining back pressure on the membranes of the reverse osmosis unit, creating a constant flow to the thermal separation units.

The present embodiment has a cross-flow filtration system within the reverse osmosis unit. In this type of filtration, only a portion of the feed stream passes through the filter medium in a perpendicular flow. The remainder of the feed stream flows parallel to the medium and exits the housing, thereby sweeping the residual salts and pollutants from the membrane surface. This is the type of filtration required for the application of reverse osmosis.

With reverse osmosis, as pressure forces waste water, sometimes described as permeate, or product, through the membrane, the solution on the pressure side of the membrane becomes increasingly concentrated. To prevent this concentration from reaching saturation levels and precipitating on the membrane surface, a predetermined amount of the concentrated feed stream must be allowed to carry away the residual salts. This concentrated residual is normally called brine, concentrate or reject water, which is shunted to the thermal units herein for concentration and vaporization of the remaining water portion.

As previously noted, the water is reclaimed continuously while redundant filter systems, and thermal units alternatively operate to continuously clean the water and be purged of clogging solids. This fracture unit, operating at a temperature of about 2800° F. (1538° C.), vaporizes all solid matter filtered from the water and reduces it to elemental ash thereby substantially reducing its volume and facilitating efficient cleaning of the system.

### BRIEF DESCRIPTION OF THE DRAWINGS

FIG. 1 is a schematic drawing of the overall process of the present invention.

FIG. 2 is cross-sectional view of an ionizer used on the present invention.

FIG. 3 is an end view of the ionizer.

FIG. 4 is side view of a 3″ slotted copper pipe forming an interior portion of the ionizer.

FIG. 5 is a side view of a 2″ slotted copper pipe forming a concentric unit portion of the ionizer.

FIG. 6 is a schematic view of the thermal heater casing of the present invention.

FIG. 6a is a cross-sectional view of the thermal heater casing and coil insert of the present invention.

### BRIEF DESCRIPTION OF THE APPARATUS AND METHOD OF A BEST MODE OF THE INVENTION

Design of this water treatment unit has been based upon a given water sample source typically found in the frac water recovery business. While ranges can vary, the existing design disclosed herein should be able to clean most frac waters without significant changes in the filtering or reverse osmosis units. However, changes in the actual source water analysis can change the performance of the unit.

### Design Performance

The existing disclosure is made for frac water at about 25° C., containing about 36,000 ppm of total dissolved solids. The inlet to the filter system is set for about 75 gallons per minute (GPM) at about 60 psi, with a maximum psi of 100. The outlet of the filter system should produce about 75 GPM at 40 psi, having a maximum not greater than 80. Backwash inlet flow or feed is set to about 150 GPM at 30 psi minimum and the backwash outflow is about 150 GPM at 40 psi, with an 80 psi maximum.

The reverse osmosis (RO) unit is designed at accept an inflow of about 75 GPM at 40 psi, with a maximum of 80, a production flow rate of 45 GPM at 30 psi max and 30 GPM at 60 psi max to avoid damage to the RO filters. This should provide a reject water rate of 75 GPM with about a 60% recovery rate at the inlet water temperature. Clean water production should contain less than 500 ppm total dissolved solids after three years of operation under normal circumstances. This design could be scaled up to accommodate higher volumes of contaminated water. The present configuration is designed to be operated on skid-mounted units trailered to a site for use, but could be permanently affixed without departing from the spirit or intent of this disclosure. Moreover, this design could be adapted to run in duplicate configuration to provide constant operation of the water reclamation process if so desired.

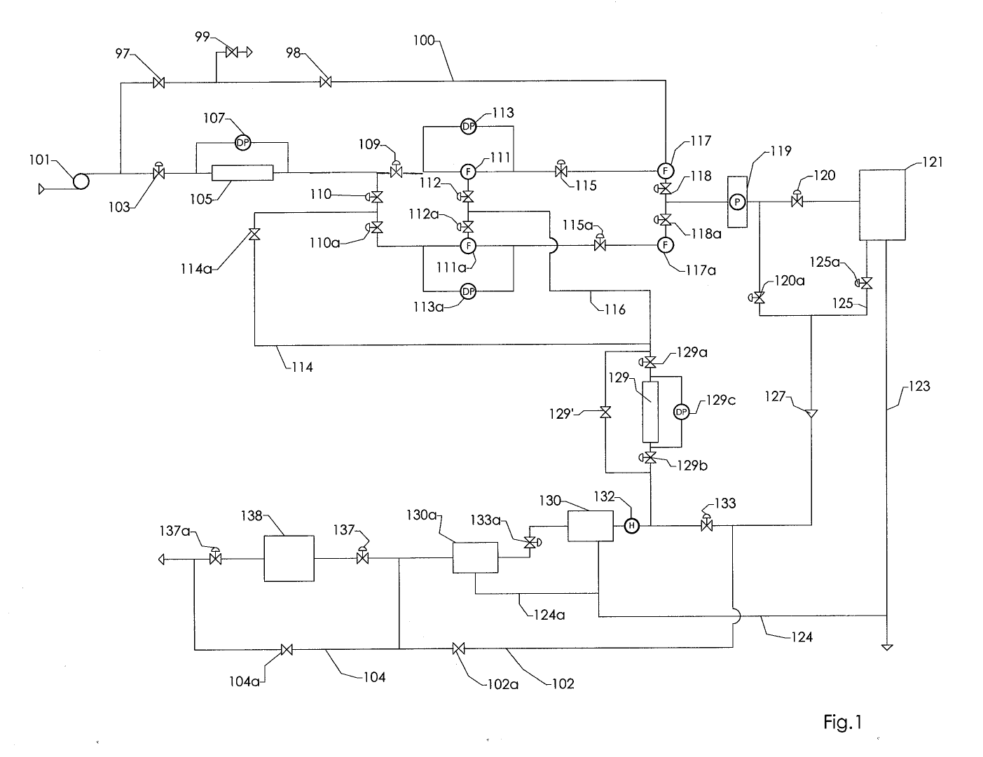

By specific reference to FIG. 1, the process can be described for frac or contaminated water held in a reservoir, which is delivered using a high capacity 3″ pump 101. The pump 101 is submersible and can be maneuvered to anywhere on site with a flex hose connection. The production water that has been pumped back up to the surface or from the contaminating usage (herein described simply as contaminated or waste water), is pumped by the high capacity pump 101 to the first stage of ionization through a control valve 103 to the primary ionizer 105 to begin the treating process. The high capacity pump 101 maintains sufficient pressure on the inflow line of the contaminated water to cause the water to move through the primary ionizer 105 at a more or less constant differential pressure measured by meter or gauge 107. From the primary ionizer 105, the contaminated water flows into the 5-micron (5-μ) filter 111 maintained at a constant differential pressure to drive the water through progressively finer particles then into a 1-micron filter system. Control over the differential pressure is maintained on the 5-micron filter system by gauge 113. The pressure drop experienced by the contaminated water pressure flowing through the filters 117, 117a is again maintained by high-pressure pump 119 at the outlet of the 1-micron (1-μ) filter system clearing the filter subsystem and providing wastewater pressurized flow into the reverse osmosis unit 121. The ionizer unit 105 is designed to operate between 70-150 psi, with a minimum of 60 psi. High-pressure pump 119 maintains an operating inlet pressure of at least 35 psi. If pressure on the inlet to this pump drops below that level, the system shuts down for possible backwash and clearance of the filters or determination of the cause of the loss of through-put pressure.

A bypass line 100 can be used by move contaminated water either through manual valve 97 to be dumped through manual valve 99 or through manual valve 98 into the filter system 117 if required, while the system comes up to operating temperature and pressure. Valves 109, 110, 110a can be selectively actuated to bypass contaminated water flowing from the ionizer 105 through line 114 controlled by a manual valve 114a to a second ionizer 129 to completely bypass filter through the media filters 111, 111a, 117, 117a or through the reverse osmosis unit 121 if the contaminated water warrants only minimal treatment.

The 5-micron (5-μ) filter system 111 provides a redundant filter path 111a allowing continuous filtering of the input stream of contaminated water, while backwashing the redundant filter system measured by gauges 113, 113a to assure constant differential pressure through each filter.

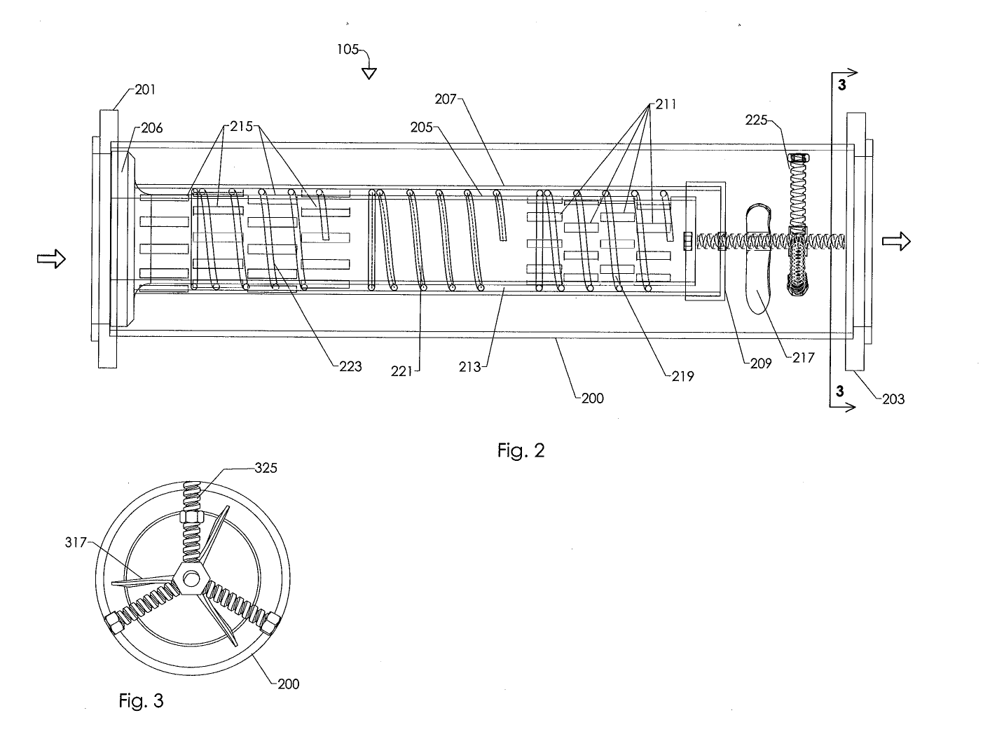

As more fully shown in FIG. 2, contaminated water enters the ionizer 105 with a tubular body 200 providing a flanged end 201 at its inflow side and a flanged end at its outflow side 203. Concentrically seated within the tubular body 200 are an interior copper tube 205 having a belled upper lip 206 seating within a second interior copper tube 207 both copper tubes seated in a cap 209 such that inflow water moves into the interior copper tube 205 through a plurality of slits 211 cut into the outflow end of the interior copper tube 205 then into an annular space 213 between the interior copper tube 205 and the larger diameter second interior copper tube 207. Each of the slots 211 cut in the interior copper tube 205 are staggered in each row and are positioned circumferentially around the end of the tube 205. The interior copper tube 205 is 2″ in diameter providing four rows of ten evenly spaced slots, 0.125″ wide and 1.5″ long commencing 2″ from the outflow end of the tube. Successive rows show the slots staggered from the preceding row. The interior copper tube 205 in the preferred embodiment is 22¾″ long.

FIG. 3 is an end view of the ionizer body showing the supporting arms 325 (shown as 225 in FIG. 2) which center and stabilize the ionizer core within the body 200 and shows a free-flowing propeller assembly 317 (shown as 217 in FIG. 2) which spins within the outlet end of the assembly to provide turbulence to minimize laminar flow of the fluid from the ionizer. Returning to FIG. 1, it should be noted that the physical structure of ionizer 105 is duplicated in the second ionizer 129, which performs the same service on that outlet stream of contaminated water. Inflow supply through line 116 is controlled by automatic valve 129a and outlet by automatic valve 129b while gauge 129c detects and maintains constant differential pressure through this second ionizer 129.

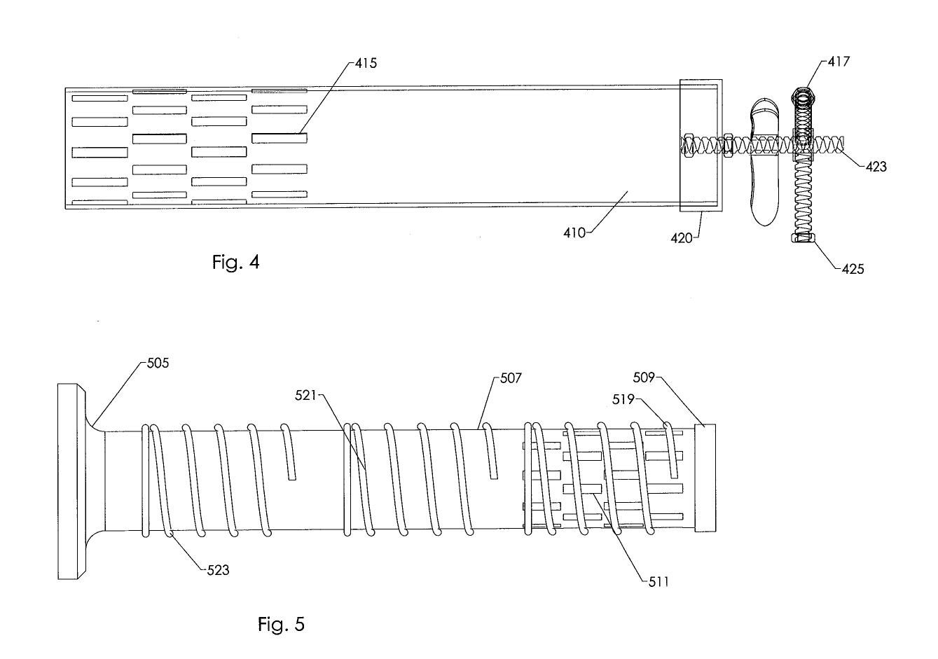

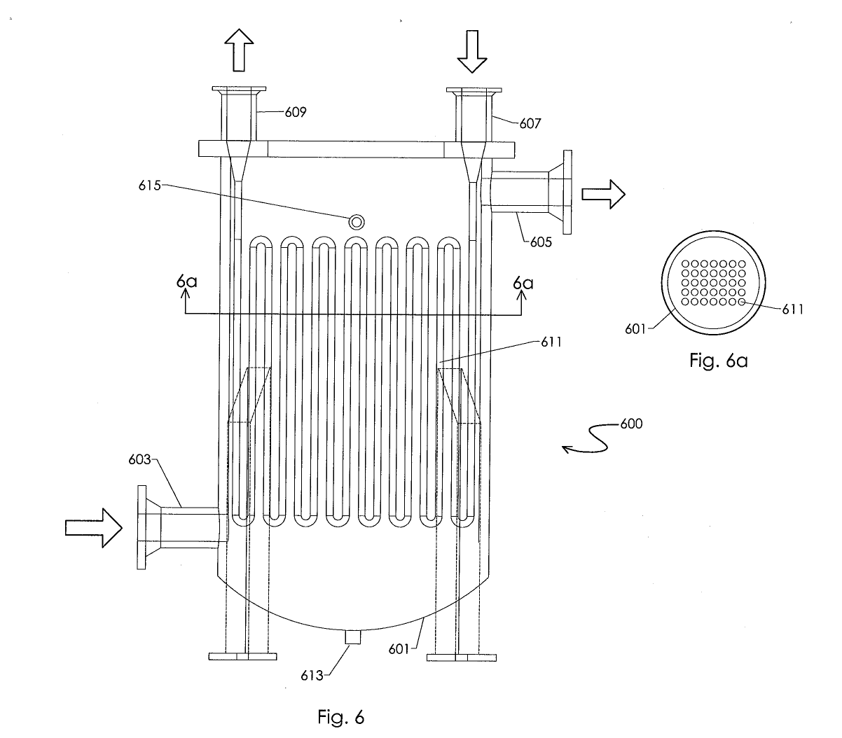

FIGS. 4 and 5 describe the concentrically spaced copper tubes forming the body of the ionizers. FIG. 5 describes the interior smaller copper tube 507 which provides a flange or belled upper lip 505 at its proximal end for seating against the ionizer tubular body 200 (as shown in FIG. 2) which is wrapped with a first silver coil 519, then a copper coil 521, then a second silver coil 523. The waste water flows into this interior smaller copper tube shown, then exits through the slots 511 at the tubes distal end 509 which is capped. The waste water contacts the silver coils 519 first, then flows over the copper coils 521, then the second silver coils 523, and finally exits through adjacent slots shown in FIG. 4 at 415. FIG. 4 is a more detailed view of the larger exterior copper tube 410 and a cap 420, the tube providing slots 415 cut in the proximal end to allow ionized waste water to flow out of the tube into the annulus of the body 200 as shown in FIG. 2. The propeller 417 of FIG. 4 and the support arms 425 are also shown.

FIG. 2, depicting the assembled FIGS. 4 and 5, shows the larger diameter second copper tube 207, which is similarly fabricated with four rows of slots 215 similar to the smaller interior tube 205. Each slot is 1.5″ long and 0.125′ wide and the series of slots commences 1″ from the outflow end of the tube. These slots 215 allow contaminated water flowing through the annular space 213 from the slots 211 to flow out the slots 215 into the interior of the ionizer tube 200 and out past the cap 209 across a turbulence-inducing propeller and out of the ionizer body 200.

Colloidal particles dispersed in an ionic solution are electrically charged due to the ionic characteristics of the particles and dipolar attributes of the molecules suspended. Each particle typically is dispersed in a solution surrounded by oppositely charged ions creating a fixed layer. Outside the fixed layer are varying compositions of ions of opposite polarities. This diffuse double layer is on the whole electrically neutral. Creating a streaming potential of the suspended ionic particles therefore is intended to permit the attraction of the particles to an opposite polarity, sliding the particle away from its diffused oppositely charged ion thereby aggregating previously dispersed particles, making them easier to filter.

The ionizer 105 in FIG. 1 also provides electrochemically dissimilar coils made from copper and silver helically wound around the exterior of the inner small diameter copper tube 205 of FIG. 2 and in the annular space 213. The lower coil 219 is silver, the intermediate coil 221 is copper and the upper coil 223 is also silver. Contaminated water is forced through both the copper pipes over the silver and copper coils thereby creating a streaming potential facilitating removal of the contaminated solids from within the electrolytic solution. As more clearly shown in FIG. 1, the use of the ionizer 105 at this stage facilitates clearance of particulate matter in the contaminated water in the staged filter system comprised of the 5-micron filter 111 and the following 1-micron filter 117, then further cleaning in the reverse osmosis unit 121. The presence of the high-pressure pump 119 assists in maintaining a substantial pressure drop on the 1-micron filter 117 and high pressure on the reverse osmosis unit 121 to permit more complete mass transfer of the contaminated water through each filter system. The creation of the supernatant contaminated water prior to reaching the reverse osmosis unit 121 makes this water reclamation system highly efficient. Again, the redundant system using automatic valves 112a, 115a, and 118a permit the 1-micron filter 117a to be used while exchanging the parallel filter system. Output from the high pressure pump 119, can also be diverted by closing automatic valve 120 and opening automatic valve 120a sending the filtered contaminated water into the sonic reducer 127 to the heater units 130, 130a past automatic valve 133 and the inline heater 132.

The potential created by forcing the contaminated water through both ionizers 105, 129 permits hydrophilic particles to release from the water molecules thereby permitting ready filtering and the osmotic function of the ionized contamination stream. Both ionizers 105, 129 are self-contained systems and can be readily replaced for scheduled maintenance. The Zeta potential (ζ-potential) created therein is familiar to persons having ordinary skills in the filter system art, and has been measured for various solution chemistries. The effects of salt (NaCl) concentration, solution pH, and the presence of other dissolved substances, such as humic substances found in ground water sources of frac fluid all affect the electrokinetic qualities of filter systems and are highly relevant in reverse osmosis units. Humic substances strongly absorb on the surface of reverse osmosis filter systems and thus alter the surface charge of the membrane. The ζ-potential becomes more negative as the NaCl concentration in solution increases. Thus, the efficiency of reverse osmosis membranes is highly influenced by the presence of unreacted chemical substances or impurities on the membrane surface. Colloids and particulate matter deposit on the surface of the filters and increase the resistance to water flow through the membrane.

A number of factors affect the electric surface charge on the membranes. These factors include dissociation (ionization) of surface functional groups, adsorption of ions from solution, and adsorption of polyelectrolytes, ionic surfactants, and charged macromodules. Exact knowledge of the intricacies of the electro-kinetic properties of this system is not required to appreciate the substance of this invention and is not necessary to replicate in the disclosure made herein. Nevertheless, it is believed that several different polymeric membranes contain ionizable surface functionalities, such as carboxylic (R—COO⁻), amine (R—NH₃⁺), and sulfonic (R—SO₃⁻) surface groups. Surface charge on those ions arises from the protolysis of these functional groups. The surface charge is dependent on the degree of ionization and, hence, the pH of the aqueous solution. As may be appreciated, at low pH values, a membrane surface with amine functional groups can be positively charged, while a moderate to high pH value, a membrane with carboxyl functional groups, can be negatively charged. The filter system of the present invention therefore accommodates both modalities.

Even in the absence of ionizable functional groups, polymeric membrane surfaces can acquire a surface charge through adsorption of anions from solution. Preferential adsorption of anions has been described as a source of surface charge on non-ionogenic surfaces (i.e., surfaces with no ionizable functional groups), such as hydrocarbon mixes or hydrophobic colloids. A solute that is hydrophobic in character will readily absorb onto a solid surface. For polyelectrolytes, absorption arises from London-van der Waals forces, hydrophobic bonding of nonpolar segments, hydrogen bonding, electrostatic attraction, and chemical reactions with surface functional groups. The ionizer-filter system claimed herein provides structure that permits long and efficient operational runs without down-time associated with repetitive backwashing or replacement of filter elements.

Electrical theory suggests that surface charge is modified and compensated by counter-ions in the electrolytic solution close to the surface, forming an electrical double layer. The distribution of ions at the solid-liquid interface can be described by several models. The primary source of the electric double layer is that the surface charge is balanced with counter-ions, some located very close to the surface, in the Stern layer, with the remainder distributed away from the surface in the diffuse layer. Measurements within the Stern layer are highly correlated with the ζ-potential. The relative motion between the electrolyte solution and a charged solid surface can result in one of four electrokinetic effects—electrophoresis, electro-osmosis, sedimentation potential or streaming potential. Streaming potential results from the liquid phase in movement and the solid phase stationary and the sedimentation potential results from solid phase in movement with the liquid phase stationary. Here, the mechanical forces driving the wastewater over the surfaces of the ionizer permit agglomeration to occur in the solids in solution and ready removal of these solids through each filter system. Thus, the high capacity pumps 101, 119 are critical to the movement of fluid through the present system. Without adequate flow into the primary ionizer 105, the ζ-potential cannot be realized and the separation of solids from the water will be hindered. Additionally, fouling or clogging of the downstream filters will more readily occur. If the contaminated feed water is sufficiently clear, the filters can be bypassed and the secondary ionizer 129 used to dump the relatively clean water into the heater sequence. Clean water may also be diverted with manual valve 129′ to the heaters for vaporization.

The flow back feed water continues through the first stage of filtration collectively referred to herein as the Micron Filtration Unit (MFU) 111, 111a. The MFU is a system that consists of two multimedia filters 111, 111a enclosed in pressurized tanks. These multimedia filters contain graduated filter beds, which filter large particle sizes and low density at the inflow side of the MFU and progressively become smaller and denser at the outflow side. These filter systems are commercially available and may be acquired for easy replacement throughout the world. The water enters the top of a vertically disposed filter and is forced through the filter beds exiting in a flow line at the bottom of the filter vessel. The filters are designed to treat 100 gpm of contaminated water with one filter in service, while the other is in backwash process. To backwash, the flow process simply needs to be reversed. This system is contained in a skid-mounted unit allowing ready replacement of the MFU.

The process is continued to the Reverse Osmosis Unit (ROU) 121 which consists of two 1-micron filters 117, 117a and six reverse osmosis membrane units that are 48″ long (not shown in detail herein). This commercially available reverse osmosis unit is well known in this industry and can be acquired as a unit. This unit is shown in FIG. 1 as reverse osmosis unit 121. The micron filters 117, 117a catch any remaining solids larger than one micron and greatly increase the production rate of the membranes within the reverse osmosis tubes. Between the MFU and ROU, there is a high-pressure pump 119 that boosts production water through the membranes at 500 psi at a constant 100 gpm. A sizeable percentage of clean water moved through outlet line 123 is produced and the remaining is reject water removed from the ROU through outlet line 125 to the thermal units 130, and 130a.

With reverse osmosis, as pressure forces water (including the permeate, or product) through the membrane, the solution on the pressure side of the membrane becomes increasingly concentrated. To prevent this concentration from reaching saturation levels and precipitating on the membrane surface, a predetermined amount of the concentrated feed stream must be allowed to carry away the residual salts. This effluent is shown coming from the reverse osmosis 121 on FIG. 1 through line 125. This concentrated residual is normally called brine, concentrate or reject water.

The relationship between the amount of permeate produced by a reverse osmosis system and the feed stream is known as the conversion rate (or recovery rate) and is expressed as a percentage. E.g., if 30 gallons of permeate are produced for every 100 gallons of feed, the conversion rate is 30%. Primarily, the source water determines the conversion rate of a particular reverse osmosis system. That is, the number and types of salts dissolved in the water and their levels of concentration influence the efficiency and capacity of the present unit, but it is believed that a person having ordinary skill in this art would be able to adjust the operation of the unit to maximize the quantity and quality of the reject water and the cleaned water from this system.

Reject water, from the reverse osmosis unit 121, is controlled by a custom inline sonic reducer 127 that controls back-pressure on the reverse osmosis unit 121 membranes and creates a constant flow to the thermal units 130, 130a, the next process. This system is contained in a skid-mounted unit, again to assist in ready repair or replacement.

Reject flow at operating temperature of between 40-85° F. (7.2-25.4° C.) then goes through two thermal units 130, 130a in a series that are heated by a 50 kW or larger inline heater 132 and exhaust gas from the onboard diesel generator (not shown herein) to a temperature of between 190-250° F. (87.7-121.1° C.) in the first unit 130 and between 250-410° F. (121.1-210° C.) in the second unit 130a, both of which are operated at between 5-27 inHg (2.45-13.26 psi) As more fully shown in FIG. 6, the heater is bayonet coil heater 600 vertically mounted within a vessel or casing 601, which accepts the hot exhaust from both the onboard diesel and the inline heater through port 607. This exhaust then circulates through the coils 611 which runs through reject water entering the thermal unit through port 603. Reject flow is then flashed into vapor, releasing any remaining particulates and the vapor is purged at a constant flow back through port 605 into the clean water discharge. The vapor returns to the clean water line 123 through lines 124 and 124a. Heat returns though outlet 609, which is then directed to the second thermal unit 130a where it retains sufficient residual energy to cause the remaining water to vaporize. Because the flashing chambers of the two thermal units 130, 130a of FIG. 1 maintain a constant vacuum to temperature ratio, the injected water flashes to vapor at temperatures well below 100° C., thereby using much less energy than would be required at a standard temperature and pressure. Pressure and temperature in each thermal unit is monitored through sensors installed at port 615 on each thermal unit. The volume of wastewater and solid particulates flushed and flowing out of port 613 is reduced to less than 10% of the original volume of the inflow volume. The waste stream from port 613 is then processed in the second heater 130a past the automatic valve 133a, which vaporizes the remaining water which flows through line 124a to return to the clean water discharge line 123. The contaminants move to the fracture or pyrolysis unit 138, which accepts the remaining output from the second thermal unit 130a, heating the residual slurried effluent from the second heater 130a through an plasma gasification/plasma torch nozzles which provide temperatures high enough (believed to be above 20,000° C. at its center) to completely break down all contaminants in the effluent into their elemental parts, either vaporizing them or cause them to fall to the bottom of the fracturing unit. The fracturing unit 138 operates at an average temperature of about 2800° F. (1538° C.). Fracture unit 138 is an oven providing an interior surface containing refractory bricks either vaporizing the solids which are then vented to the atmosphere or reducing all particulates to a fine ash which drops to the bottom of the fracture unit 138, which can be then disposed in an environmentally responsible manner. Air quality testing in conformity with US Environmental Protection Agency standards, performed on the stack outlet from the fracture unit 138, suggests air quality standards remained within EPA approved ranges.

Processed but not completely cleaned water can be by-passed around the fracture unit by automatic valves 137 and 137a which can move brine through line 102 through manual valve 102a to line 104 and manual valve 104a to the outlet of the system.

The water output in line 123 is substantially free from all contaminants, and can then be discharged to the ground without environmental concerns or reused in the drilling operations. The system has the capacity to process 2000 barrels of “frac” water per day.

The power source for this process is provided by a diesel generator and depending on job size will vary in size. The generator provides sufficient power to all units and all pumps. After the fracturing process, both diesel and fracture unit vapors exhaust vents to the atmosphere within EPA regulation emissions.

Tests performed on frac water indicate substantial removal of contamination from the water. For example, on samples pulled before and after from a frac job the following was observed:

| | Unprocessed | Processed | Percent |
|---|---|---|---|
| Parameter | frac water | frac water | removal |
| Aluminum, mg/L | 0.969 | 0.007 | 99.3 |
| Barium, mg/L | 164 | 0.093 | 99.9 |
| Cadmium, mg/L | 0.006 | 0.002 | 66.7 |
| Calcium, mg/L | 5975 | 4.31 | 99.9 |
| Chloride, mg/L | 31,700 | 143 | 99.5 |
| Chromium, mg/L | 0.04 | 0.001 | 97.5 |
| Iron, mg/L | 30.7 | 0.038 | 99.9 |
| Lead, mg/L | 0.171 | 0.009 | 94.7 |
| Magnesium, mg/L | 417 | 0.408 | 99.9 |
| Manganese, mg/L | 4.23 | 0.005 | 99.9 |
| Potassium, mg/L | 237 | 2.45 | 99.0 |
| Silver, mg/L | 0.006 | <0.00016 | >97.3 |
| Sodium, mg/L | 18,200 | 60.2 | 99.7 |
| Specific Conduc- | 105,400 | 527.8 | 99.5 |
| tance, μmhos/cm | | | |
| Sulfate, mg/L | 49.9 | 2.31 | 95.4 |
| Total Dissolved | 51,330 | 282 | 99.5 |
| Solids, mg/L | | | |

As may be readily appreciated, the process and apparatus described herein substantially reduce the dissolved solids content of contaminated water (in this situation, returned frac water) and substantially alters the electrochemical characteristic of the water prior to completion of the process. Removal of each of these metals from the water stream prior to completion of the process permits the returned water to be substantially reusable after treatment.

This invention has been shown and described with respect to several preferred embodiments, but will be understood by one having ordinary skill in the art to which this invention pertains that various changes in the form and detail from the specific embodiments shown can be made without departing from the spirit and scope of the claimed invention.

1. A water reclamation apparatus comprising:
an ionizer unit connected to a pressurized source of contaminated water;
a filter system comprised of a series of staged filters connected to the ionizer unit;
a reverse osmosis unit connected to the filter system;
one or more thermal concentrator units connected to the reverse osmosis unit; and,
a fracturing unit connected to the one or more thermal concentrator units.

2. The water reclamation apparatus of claim 1 wherein the ionizer unit comprises a outer copper tube concentrically covering an inner copper tube providing communicating slits at opposed ends of the copper tubes and both tubes retained within a sleeve by a reducing lip on an inlet to the inner copper tube and a cap sealing the outer and inner copper tubes at a bottom of the sleeve.

3. The ionizer unit of claim 2 further comprising an adjustable centralizing support retaining the copper tubes within the sleeve and a turbulence-inducing attachment inhibiting laminar flow of water from the ionizer.

4. The ionizer unit of claim 2 further comprising a helical coil of silver, a helical coil of copper, and a second helical coil of silver each wrapped around an outer surface of the inner copper tube and an inner surface of the outer copper tube providing exposure of fluid pumped through the inner tube to contact the copper and silver thereby creating a streaming potential of the electrolytic fluids contacting the copper and silver elements.

5. The water reclamation apparatus of claim 1 wherein the filter system comprises parallel inline high-flow filtration units.

6. The water reclamation apparatus of claim 5 wherein the filter system is a 5-micron filter system having an outlet communicating with a high-pressure pump system moving the water through a second 1-micron filter system to a reverse osmosis unit.

7. The water reclamation apparatus of claim 5 wherein the parallel filter system accommodates continuous operation of a first filter stream while backwashing a second filter system stream.

8. The water reclamation apparatus of claim 1 wherein the reverse osmosis filter system is attached to the parallel inline filter units to further filter and clear the water flowing in the system.

9. The water reclamation apparatus of claim 1 wherein a cleaned effluent from the reverse osmosis filter is returned to use as potable water and a rejected water line is passed through a sonic reducer maintaining back pressure on the membranes of the reverse osmosis unit creating a constant flow to the one or more thermal concentrator units.

10. The water reclamation apparatus of claim 1 wherein water is reclaimed continuously while redundant filter systems, and one or more thermal concentrator units alternatively operate to continuously clean the water.

11. The water reclamation apparatus of claim 1 wherein the fracturing unit vaporizes all solid matter filtered from the water and reduces it to elemental ash thereby substantially reducing its volume.

12. The fracturing unit of claim 11 wherein the operating temperature of the unit is about 2800° F. (1538° C.).

13. A method for cleaning water recovered from an industrial process comprising:
ionizing water pumped into the system in an ionizer;
pumping the water from the ionizer into a filter system providing a progressively finer filter system;
pumping the water from the filter system into a reverse osmosis filter and taking a clean cut of water from the reverse osmosis filter system and directing the rejected water to a thermal unit;
heating the rejected water from the reverse osmosis unit to a vapor phase returning the vapor generated to the clean water outlet from the reverse osmosis unit for further use or discharge and sending the remaining dissolved solids and liquid to a fracturing unit operated to disassociate the remaining dissolved solids into their constituent parts.

14. A method for cleaning water recovered from an industrial process comprising:
passively ionizing water pumped into the system in an ionizer;
pumping the water from the ionizer into a filter system providing a progressively finer filter system;
pumping the water from the filter system into a reverse osmosis filter and taking a clean cut of water from the reverse osmosis filter system and directing the rejected water to a thermal unit;
heating the rejected water from the reverse osmosis unit to about 250-410° F. (121.1-210° C.) returning the vapor generated to the clean water outlet from the reverse osmosis unit for further use or discharge and sending the remaining dissolved solids and liquid to a fracturing unit operated at about 2800° F. (1538° C.).
